(19) United States
(12) Patent Application Publication
(10) Pub. No.: US 2023/0229618 A1
(43) Pub. Date: Jul. 20, 2023

(54) TYPE-C TO TYPE-C CABLE WITH INTEGRATED/Interfaced USB COMPONENTS ON EACH END ALTERNATIVELY INCLUDES TYPE-Micro and Type LIGHTNING

(71) Applicant: Jacob Austin Ross, Somerville, TX (US)

(72) Inventor: Jacob Austin Ross, Somerville, TX (US)

(21) Appl. No.: 18/079,597

(22) Filed: Dec. 12, 2022

Related U.S. Application Data
(60) Provisional application No. 63/214,120, filed on Jun. 23, 2021.
(60) Provisional application No. 63/316,290, filed on Mar. 3, 2022.

(51) Int. Cl. G06F 13/42

(52) U.S. Cl. CPC G06F 13/4282; G06F 2213/0042

(57) ABSTRACT

CHARGER/SYNC CABLE, THAT'S IS TYPE C TO TYPE C WITH 2 USB A TYPE ATTACHMENTS/CONNECTORS

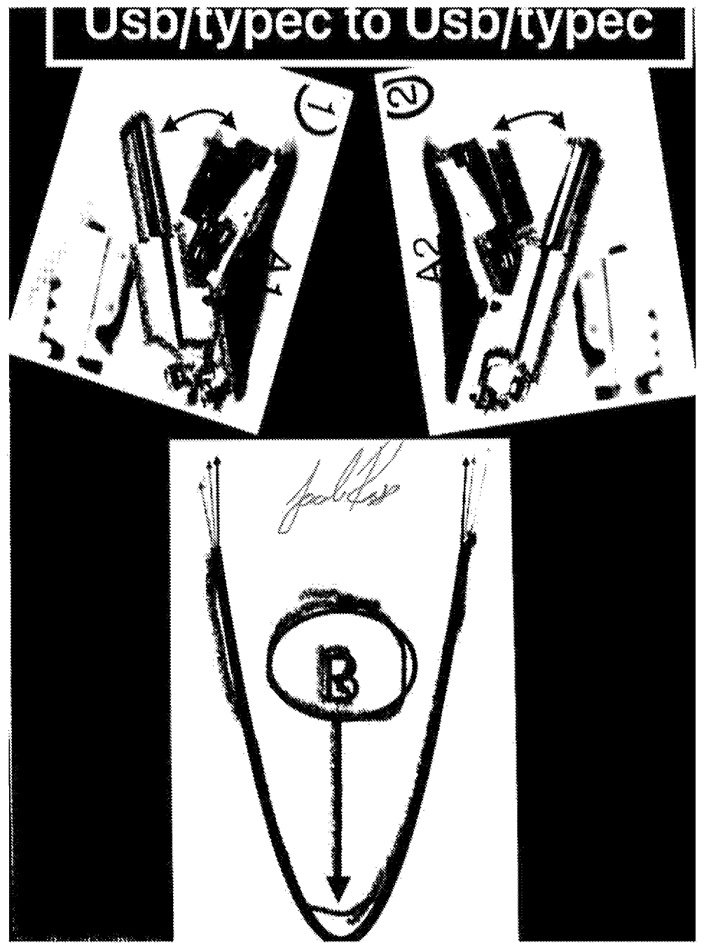

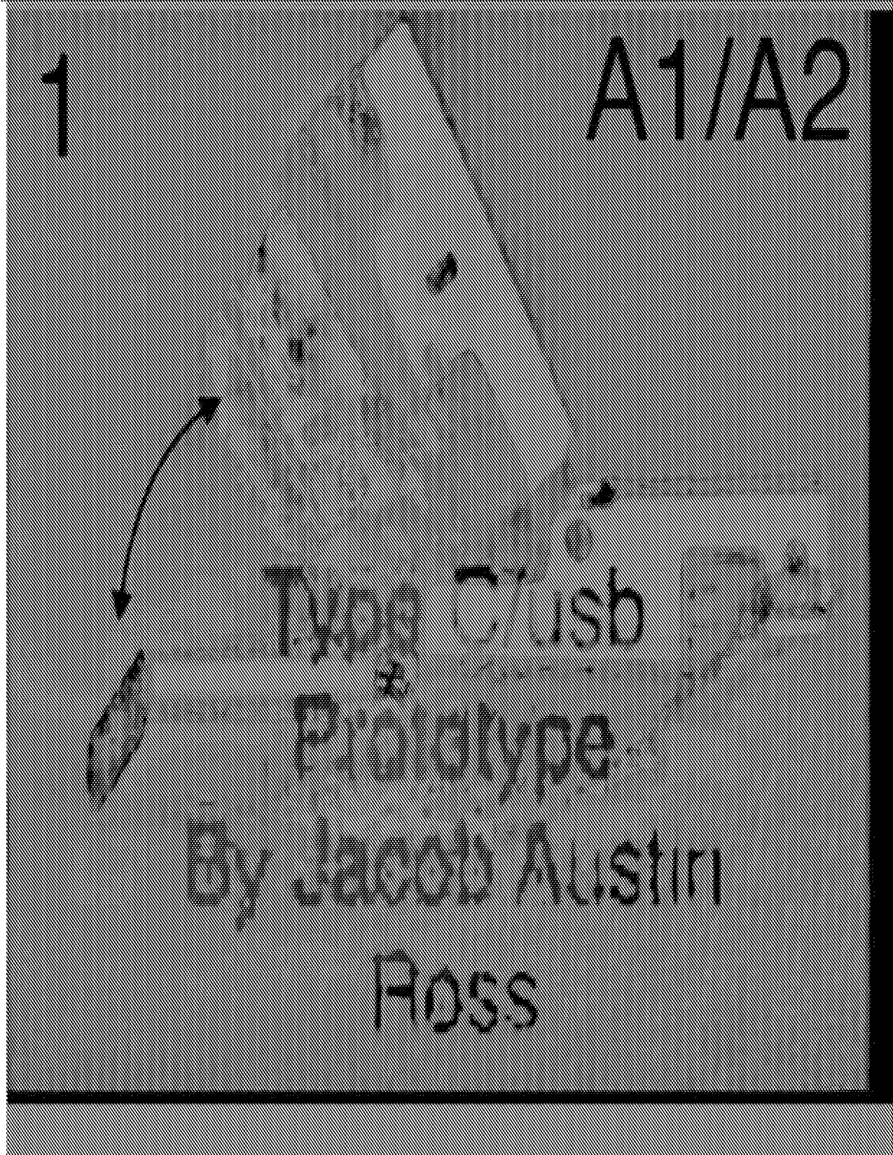

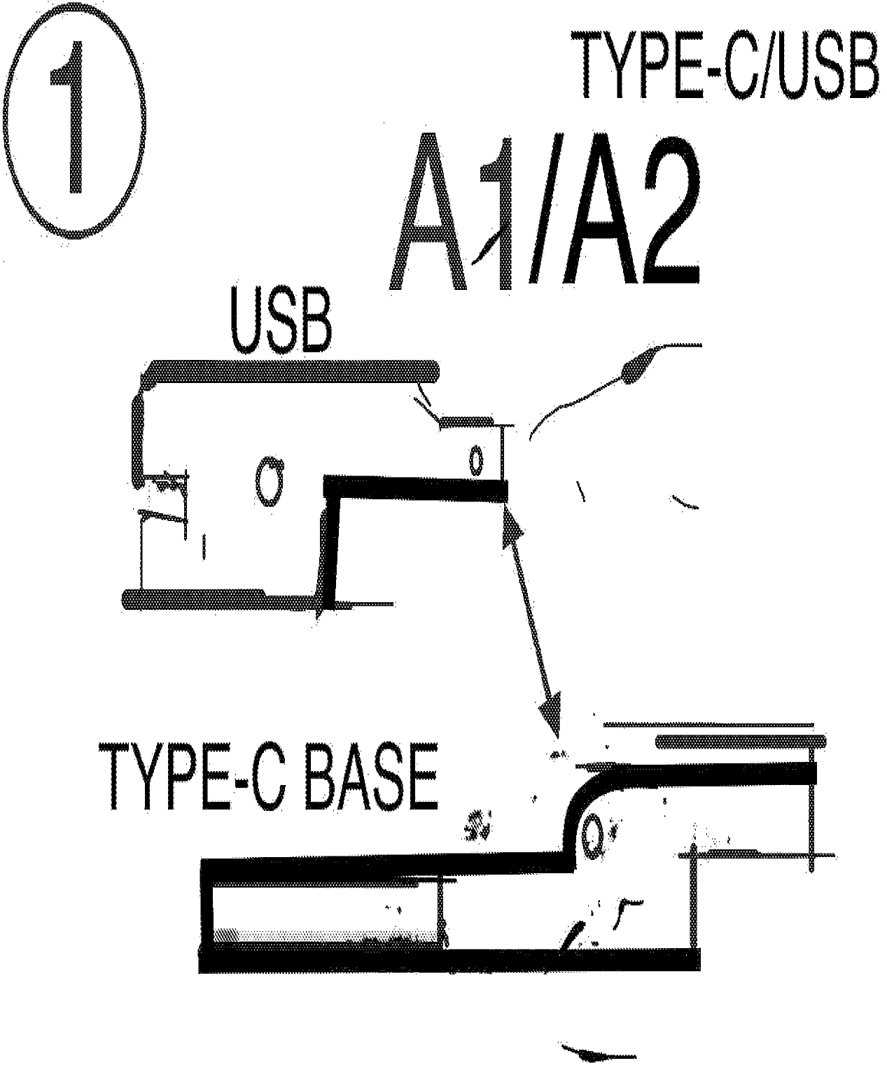

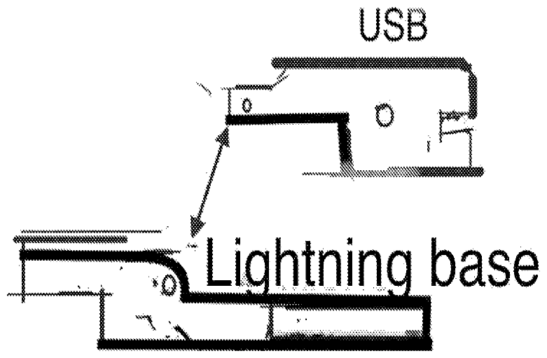

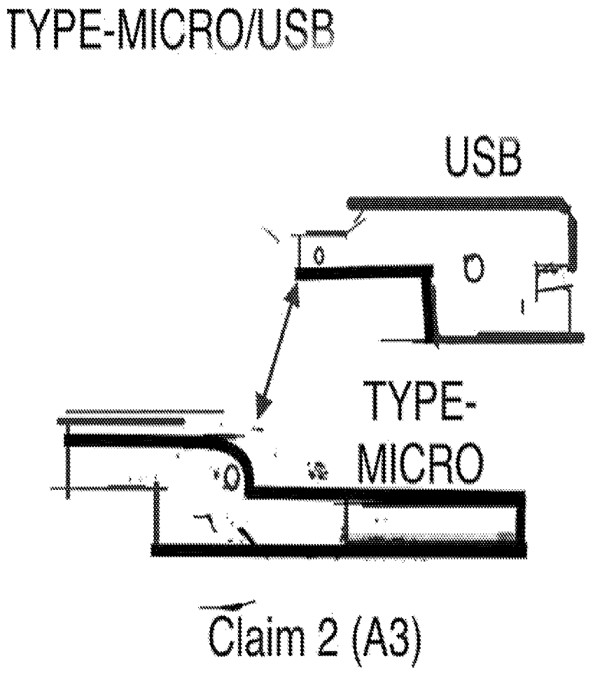

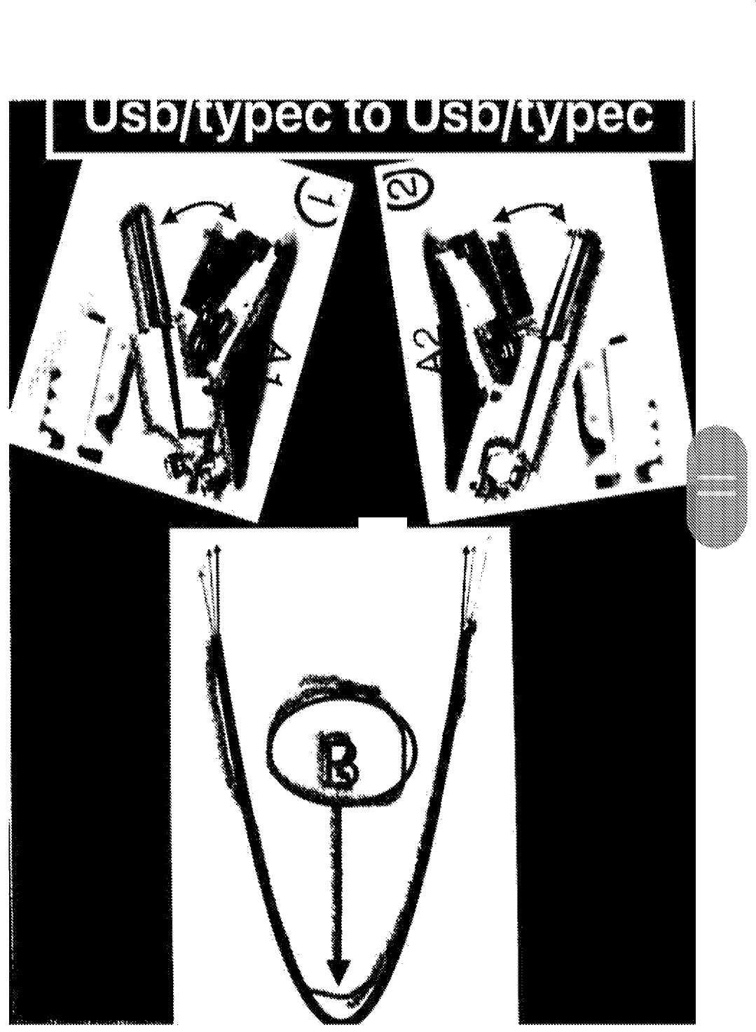

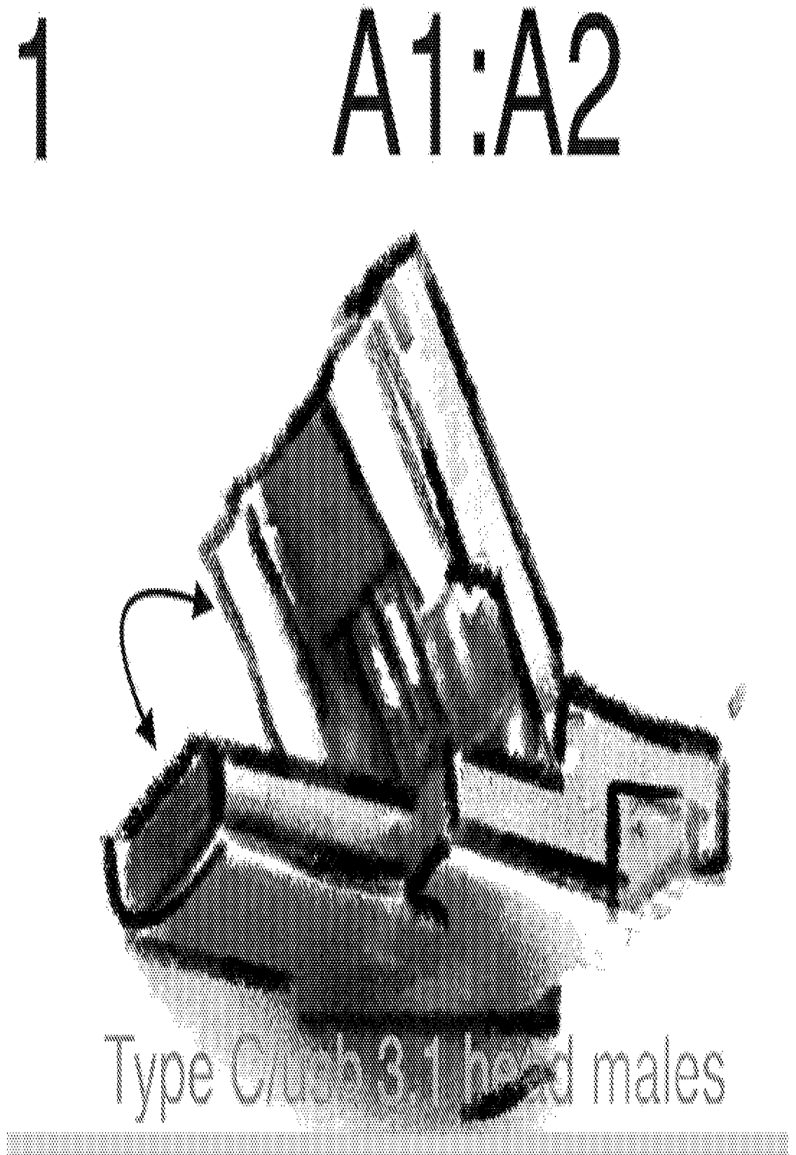

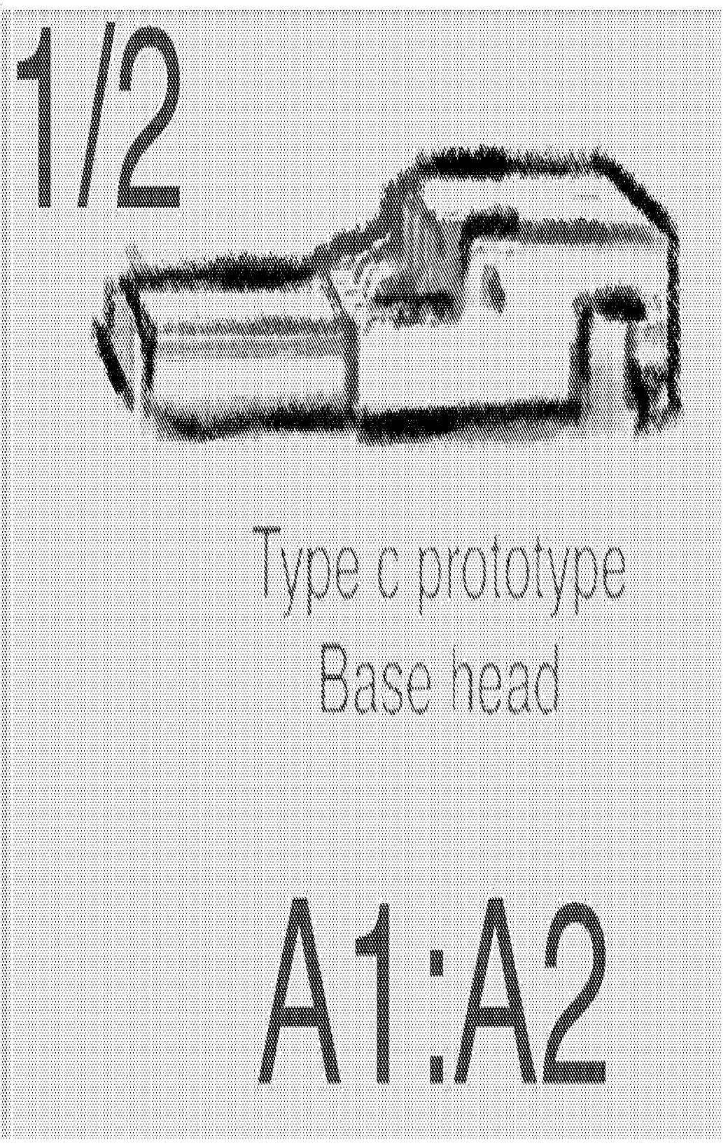

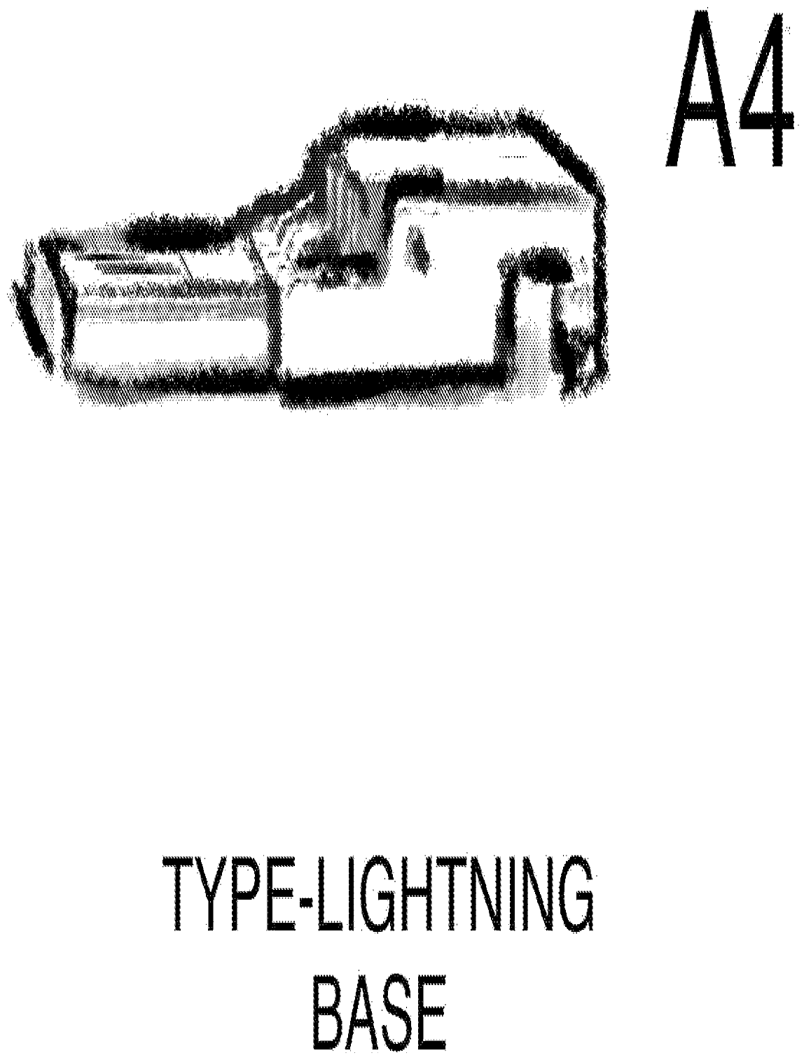

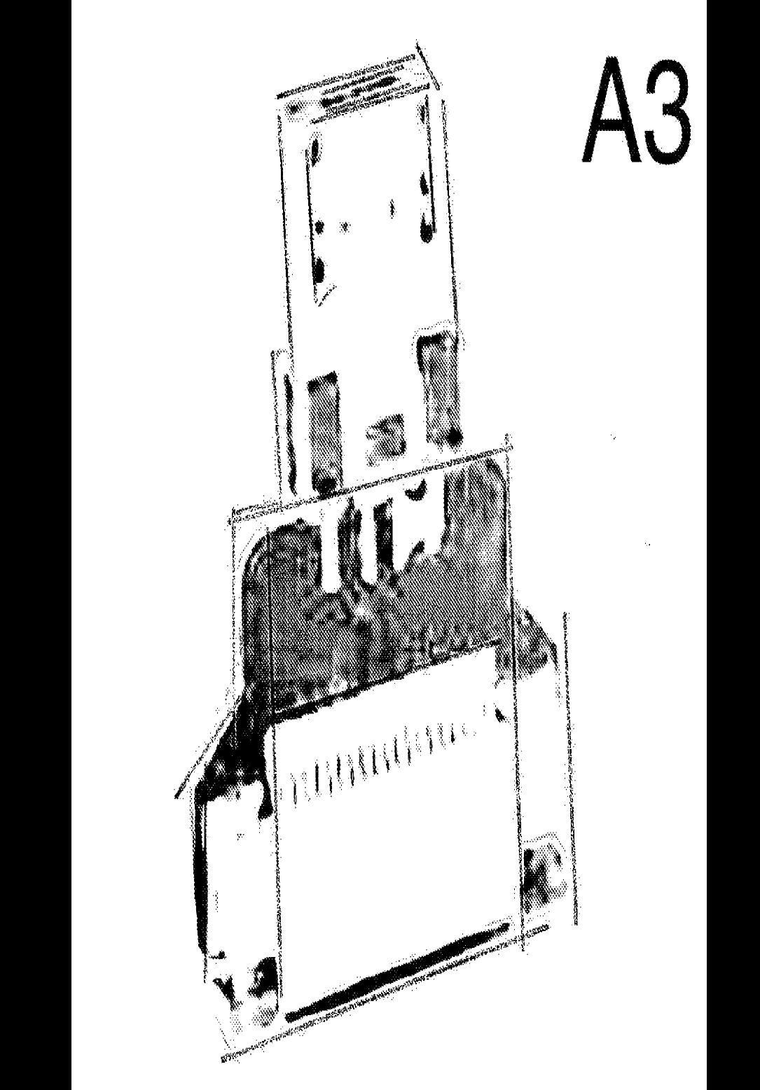

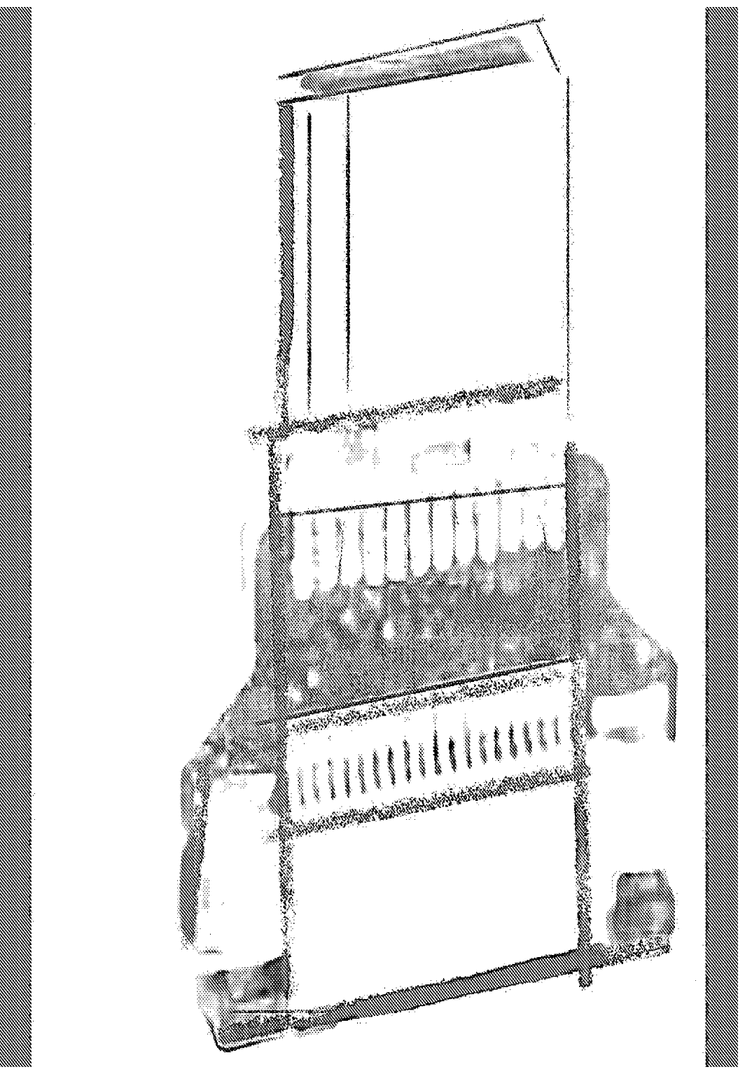

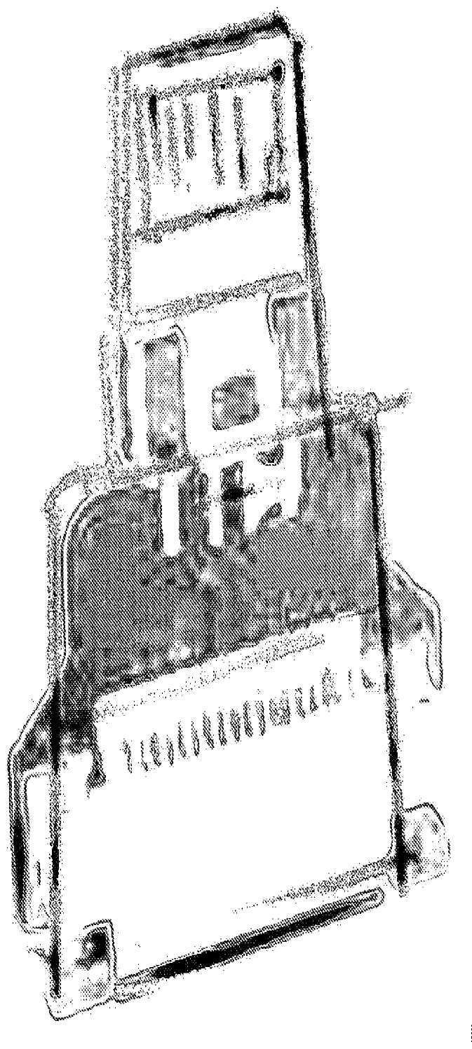

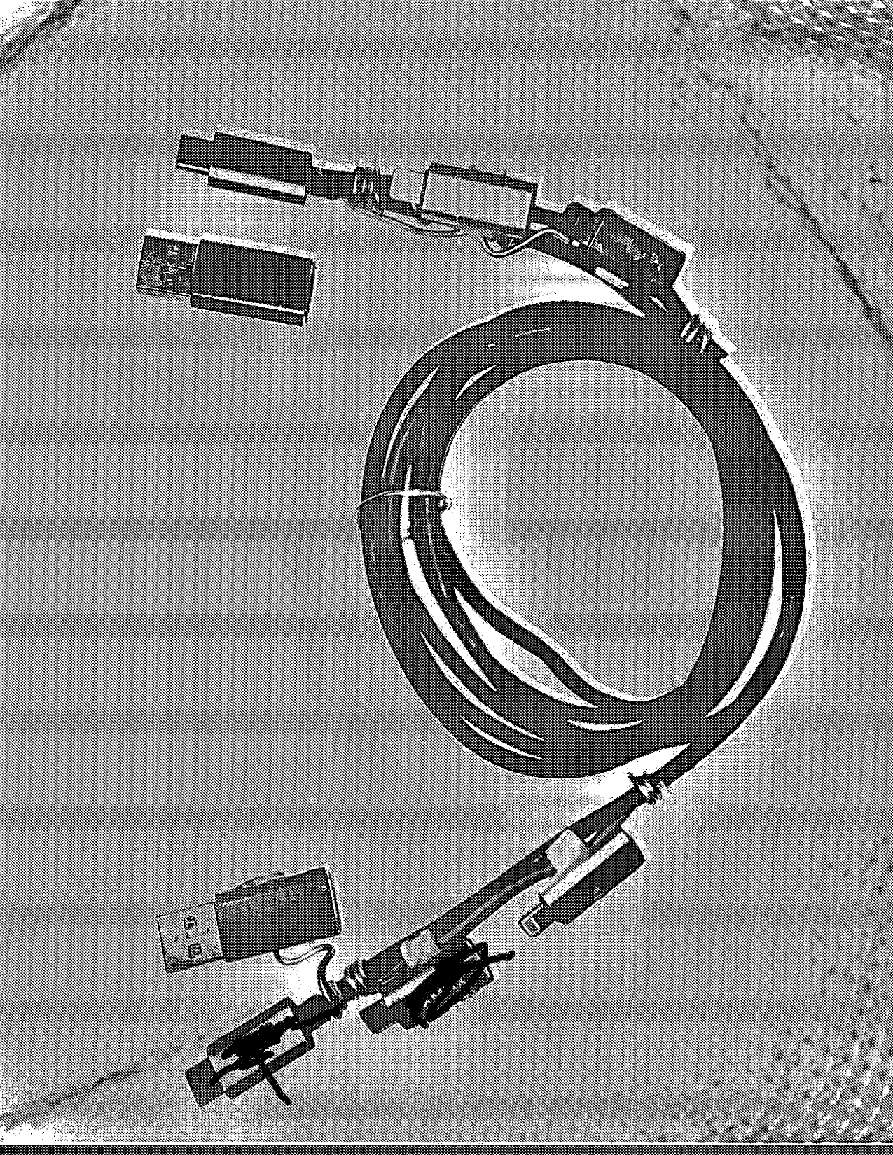

CONNECTORS/ATTACHMENTS ON BOTH ENDS THAT YOU CAN INTEGRATE TO THE BASE OTG HEAD TYPE-C AND ALTERNATES/COUNTERPARTS TYPE MICRO, TYPE-LIGHTNING.

IDEA OF TYPE C TO TYPE C WITH USB A ON BOTH ENDS, MAKES ROOM FOR ITS COUNTERPARTS THAT'S FURTHER ITS SIMPLICITY OF CONNECTORS OF MICRO, LIGHTING, TYPE C TO TRANSITION HDMI AND HDMI MINI TO INTEGRATE AS WELL INTERFACE TO CABLES/SYNC DEVICES/MECHANISMS.

### A CROSS-REFERENCED LIST OF ANY RELATED PATENT APPLICATIONS?

INITIAL PATENT SEARCH

### A STATEMENT ABOUT ANY FEDERALLY SPONSORED R&D—IF APPLICABLE?

NO

### THE NAMES OF ALL PARTIES IF THERE IS A JOINT RESEARCH AGREEMENT?

NONE

### REFERENCES TO A “SEQUENTIAL LISTING,”ANY TABLES OR COMPUTER PROGRAM LISTINGS, AS WELL AS ANY APPENDIX SUBMITTED TO A CD OR STORAGE DEVICE AND THE INCORPORATION-BY-REFERENCE LIST?

NONE

### INVENTION TITLE

USB 3.1/LIGHTNING OR TYPE C/USB 3.1 INTEGRATED/INTERFACED ADAPTER FOR CHARGER CABLE OR FLASH DRIVE OR SD READER. COMPRISED FROM AND OF PROVISIONAL PATENT 63/214,120 AND 63/316,290

### BACKGROUND OF THE INVENTION

TYPE C/USB INTERFACED/INTEGRATED HEAD OR WHATEVER MALE IS AT END CAN CONNECT WITH SAME PORT/HEAD TO PORT/HEAD.

SINCE THIS BASE IS TYPE C TO TYPE C SYNC/CHARGE CABLE HAVING THE SAME CONNECTORS ON EACH END . . . TYPE PORT/HEAD OR FEMALE TO MALE TYPE C/MICRO USB/USB A/LIGHTING, USB 2.0, USB 3.0, HDMI, YOU CAN ATTACH THEM IN A NUMBER OF WAYS OR MULTIPLE CONNECTORS ON EITHER SIDE TO MAKE THE CHARGER/SYNC OF YOUR DESIRE FOR ANY DEVICE

AS STATED, NOT HAVING TO USE 2 OR EVEN 3 DIFFERENT CABLES OR CONNECTORS TO SYNC/LINK MULTIPLE DEVICES. THE INVENTION CLAIMED HERE SOLVES THE PROBLEM. TO ELIMINATE THE USE OF 2 ATTACHMENTS OR CABLES AND SIMPLIFY THE CONNECTION AND MAKE USE OF A 2 IN 1 HEAD

THE CLAIMED INVENTION DIFFERS FROM WHAT CURRENTLY EXISTS. THERE ARE ONLY HEADS THAT ATTACH TO EACH OTHER AND DO NOT COMBINED OR INTEGRATED LIKE THIS ONE.

SOME MAY COME CLOSE BUT A HASSLE AT BEST.

THIS INVENTION IS AN IMPROVEMENT ON WHAT CURRENTLY EXISTS. THERE ARE ONLY HEADS THAT ATTACH TO EACH OTHER AND DO NOT COMBINED OR INTEGRATED LIKE THIS ONE.

SOME MAY COME CLOSE BUT A HASSLE AT BEST.

SIMULTANEOUSLY SIMPLIFIES THE USE OF DIFFERENT CHARGES OR SYNCS OR HEADS, TO MANIFEST OR MANIPULATE TO THE CONFIGURATION OF YOUR CHOICE DEPENDING ON BASE CORD SELECTION. COMPRISED OF AND COINCIDING WITH PROVISIONALS 63/214,120/63/316,290.

### BRIEF SUMMARY OF INVENTION

THAT'S THIS IS THE ONLY TYPE C TO TYPE C BASED CABLE, WITH THE ORIGINAL USB A CONNECTORS ON EACH END THAT CAN BE USED IN MULTIPLE WAYS DEPENDING ON DEVICE NEEDS, ITS COUNTERPARTS HAVE THE CONNECTORS AFTER THIS BASE IDEA TO FURTHER SYNCS AND CABLES VIA THE DIFFERENT CONNECTORS WHICH ARE FEMALE TYPE C TO MALE MICRO USB, LIGHTING, USB A, USB 2.0 MALES, THAT CONNECT UPON THE TYPE C CABLE ON EACH END. THE CLAIMED INVENTION DIFFERS FROM WHAT CURRENTLY EXISTS. THERE ARE NOT MANY CABLES OR CORDS THAT ARE BASED WITH THIS CONNECTOR USB A ON EACH END. AND CAN HAVE MULTIPLE CONNECTORS ADDED OR REMOVED ON EACH END OF THE TYPE C C TO TYPE C CORD OR THE TYPE C TO LIGHTING, OR THE USB TO LIGHTNING, OR THE USB TO TYPE C CABLES/SYNC DEPENDING ON CORD OR MODEL WHICH ARE OTHER SYNCABLE CREATIONS COMING SOON. THIS INVENTION IS AN IMPROVEMENT ON WHAT CURRENTLY EXISTS. THERE ARE NOT MANY CABLES OR CORDS THAT ARE BASED WITH USB A CONNECTOR ON EACH END. AND CAN HAVE MULTIPLE CONNECTORS FOR THE BOTH ENDS THAT ARE TYPE C FEMALE TO DIFFERENT MALE HEADS, MICRO, LIGHTNING USB 2.0. ON EACH END OF THE TYPE C TO TYPE C CABLE OR IT'S COUNTERPARTS TYPE C TO LIGHTING, USB TO LIGHTING, USB TO TYPE C CORDS/CABLES BECAUSE THEY NEED THEIR OWN SPECIFIC CONNECTORS—THIS BASE IDEA, MAKES ROOM FOR ITS COUNTERPARTS THAT'S FURTHER ITS SIMPLICITY

ALSO, FROM THIS INVENTION, A NUMBER OF SYNC/CHARGERS, DEPENDING ON THE CONNECTORS THAT ARE TYPE C FEMALE TO MULTIPLE MALE HEADS, MICRO USB, LIGHTING, USB A, USB 2.0 AND CONNECT MULTIPLE DEVICES FOR SYNCING OPTIONS OR CHARGING, WHICH BECOME AVAILABLE AND CAN CONNECT BASED OFF THE IDEA OF PUTTING USB A CONNECTORS AT EACH END OF THE TYPE C.

LIGHTNING, MICRO USB, HDMI, USB A CABLES BECOME AVAILABLE FOR CONNECTORS BOTH SINGLE AND DOUBLE SIDED CORDS, AS STATED ABOVE, EXAMPLE USB TO LIGHTING OR TYPE C TO TYPE C.

### DETAILED DESCRIPTION OF THE INVENTION REFERENCE 63/214,120, 63/316290

THESE 3 HEADS ARE ARE INDIVIDUALLY UNIQUE, AS THEY ARE EACH A HALF AND HALF OR TWO COMPOSED INTO ONE INTERFACED/INTEGRATED HEADS THAT SPLIT THE USB HOUSING AND THE ADAPTER BASE INTO A PRIMARY BASE WITH DETACHABLE USB COMPONENTS, THESE 3 HEADS TYPE C/USB.

THE OPTION FOR MULTIPLE DEVICES TO SYNC/CHARGE VIA THE CHARGER CABLE, OR FIT ONTO THE SINGLE SIDE OF A SD READER, DATA STICK, OR EVEN BLUETOOTH ADAPTABLE ITEMS, THAT FEATURE A SINGLE AS WELL AS DOUBLE SIDED DESIGNS FOR CHARGER/SYNC CABLES, SD READERS, DATA STICKS, AND BLUETOOTH ADAPTABLE HEADS, ALSO MAKING IT THE FIRST DOUBLE SIDED CHARGER WITH 2 USB ATTACHMENTS AND ITS OTHER ATTACHMENTS THAT WOULD MAKE A 4 TIP TO 4 TIP CHARGER CABLE WITH TYPE-C/USB TO TYPE-C/USB AND 3 ALTERNATE TIPS TO CHARGE/SYNC ALMOST ANY DEVICE.

THEY CAN MIXED AND MATCHED A VARIETY OF DIFFERENT WAYS DEPENDING ON THE USER SPECIFIC NEEDS,

THE HALF AND HALF FUNCTION ALSO CARRIED INTO OTHER DESIGNS AS WELL AS HDMI/TYPE-LIGHTNING, HDMI-MINI/LIGHTNING, HDMI/TYPE-C, HDMI/MICRO.

THE 3 TIP HEADS ALSO HAVE 2 IN 1 DESIGNS SUCH AS THE SLIDE UP, WHICH SLIDES A BASE ADAPTER FROM INSIDE THE USB (SLIDE-UP), THE (POPOUT) WHICH OPENS AND THE BASE ADAPTER FLIPS OUT, AND THE (SWIVEL) WHICH FEATURES THE HALF SHELL AND DOUBLE SIDED TIP HEAD INSIDE FOR CONCEALMENT.

THESE ARE ALSO ABLE TO BE BOTH ASSEMBLED TO DOUBLE SIDED AND SINGLE SIDED DESIGNS. THE CABLES THEMSELVES CAN BE DIFFERENT SIZES SUCH AS 2 FT, 3 FT, 4 FT, 6 FT, 8 FT, 10 FT ALSO DIFFERENT GIGABYTES 16 G, 32 G, 124 G, EVEN 1 TERRA-BYTE:

### Relationship Between the Components

THE TYPE C TO TYPE C CHARGES/SYNCS PHONES AND THE DIFFERENT HEADS ARE FOR DIFFERENT DEVICES BUT TYPE C IS THE BASE, #1 AND #2 CAN BE USED ON ITEMS IN #3 AND #4

### How the Invention Works

THEY WORK TOGETHER, TO CHARGE AND SYNC DEVICES VIA THE MULTIPLE ATTACHMENTS AND CAN ME SWITCHED DEPENDING ON THE USER AND HIS/HER NEEDS TO SWITCH OUT DIFFERENT HEADS TO A BASE CABLE, KNOWING WHAT TYPE OF HEADS TO CHOOSE IS UP TO THE CONSUMER

### How to Make the Invention

2 USB 3.1/LIGHTNING OR 2 USB 3.1/TYPE C ATTACHMENTS ON BOTH ENDS MAKE QUICK CONNECTIONS ON EITHER SIDE TO BLUETOOTH OR PHONE OR LAPTOP POSSIBLE TO CHARGE/SYNC/LINK MIX AND MATCH DEPENDING ON DESIRED FUNCTION AND USES.

HEADS ALSO ADAPTIVE TO INDIVIDUAL DEVICES LIKE FLASH DRIVE, SD READERS, SIM READERS TYPE C/USB 3.1 AND LIGHTNING/USB 3.1 HEADS

OPTIONAL ARE THE BASE DEVICES, CHARGER/SYNCS, SD READER, FLASH DRIVES

THEY CAN BE MIXED AND MATCHED IN DOUBLE SIDED CHARGER CABLE/SYNC CABLES, ALSO CAN BE PUT ON ANYTHING THAT HAS A USB MALE CONNECTOR SD READER, FLAGS DRIVE, CHARGER'S

### How to use the Invention

YOU WOULD HAVE TO ORDER A CUSTOM USB A/LIGHTNING USB A/MICRO INTERFACE-INTEGRATED HEAD THAT IS SIMILAR TO THE USB A/TYPE C HEAD IN FINALIZED UTILITIES PATENT, CURRENTLY PROVISIONAL PATENT 63/214,120 AND ALSO A CORD, FLASH DRIVE CHIP BODY AND SD READER BODY LOL SIMPLY PLUG YOUR DESIRED DEVICE INTO OR ONTO THE CORD DEPENDING ON LINK/SYNC/CHARGE DESIRED CAPABILITY DEPENDS ON USER DEMAND FOR ATTACHMENT

ALTERNATE AVAILABLE HEADS, ALSO CAN BE UTILIZED ON INDIVIDUAL ONE SIDED DEVICES LIKE FLASH DRIVES, SD READERS, SIM READERS.

### BRIEF DESCRIPTION OF DRAWINGS

(A1, A2)=THESE PICTURES I DREW WILL SHOW THE INTERFACED/INTEGRATED USB/TYPE-C EXPLODED VIEW INCREASED SCALE. BOTH PENCILS AND PROTOTYPE COLOR PICTURE

(A3)=THESE PICTURES I DREW WILL SHOW THE INTERFACED/INTEGRATED USB/TYPE-LIGHTNING EXPLODED VIEW INCREASED SCALE. BOTH PENCIL AND PROTOTYPE COLOR PICS

(A4) THESE PICTURES WILL SHOW THE INTERFACED/INTEGRATED USB/TYPE MICRO EXPLODED VIEW INCREASED SCALE. BOTH PENCIL AND COLOR PICTURES

FLASH DRIVE, SD CARD READER, CHARGER/SYNC (IN SEPARATE PICTURES) DOUBLE SIDED CABLES (LIGHTNING OR TYPE C OR MICRO)

### CLAIMS LISTING

### Independent Claims

### INVENTION—CLAIM 1: TYPE-C/USB.

### CLAIM 2: TYPE-LIGHTNING/USB.

### CLAIM 3: TYPE-MICRO/USB.

1. TYPE-C/USB COMPRISING OF A TYPE-C HEAD/USB HOUSING INTERFACED INTO A 2/1 ONTO CHARGER/SYNCS CABLES, FLASH DRIVES, SD READER, WITH DETACHABLE TOP HOUSINGS.

2. TYPE-MICRO/USB COMPRISING OF A TYPE-MICRO HEAD/USB HOUSING INTERFACED INTO A 2/1 ONTO CHARGER/SYNCS CABLES, FLASH DRIVES, SD READER, WITH DETACHABLE TOP HOUSINGS.

3. TYPE-LIGHTNING/USB COMPRISING OF A TYPE LIGHTNING HEAD/USB HOUSING INTERFACED INTO A 2/1 ONTO CHARGER/SYNCS CABLES, FLASH DRIVES, SD READER, WITH DETACHABLE TOP HOUSINGS.
DEPENDENT CLAIM CLAIM 1
1. TYPE C/USB AS IN claim 1; WHEREIN SAID TYPE C BASE IS INTERFACED WITH RESPECT TO USB.
2. TYPE C/USB AS IN claim 1; WHEREIN SAID USB IS INTERFACED WITH RESPECT TO TYPE C BASE.
3. TYPE C/USB AS IN claim 1; 3 WHEREIN SAID USB DETACHED AND WITH RESPECT TO TYPE C SEPARATING THE 2
4. TYPE C/USB AS IN claim 1; WHEREIN SAID USB/TYPE C CONNECT TO CHARGER/SYNC.
5. TYPE C/USB AS IN claim 1; WHEREIN SAID TYPE C/USB CONNECT TO FLASH DRIVES.
6. TYPE C/USB AS IN claim 1; WHEREIN SAID TYPE C/USB CONNECT TO SD READERS
DEPENDENT CLAIM 2
1. TYPE-MICRO/USB AS IN claim 3; WHEREIN SAID TYPE C BASE IS INTERFACED WITH RESPECT TO USB
2. TYPE-MICRO/USB AS IN claim 3; WHEREIN SAID USB IS INTERFACED WITH RESPECT TO TYPE MICRO BASE.
3. TYPE-MICRO/USB AS IN claim 3; 3 WHEREIN SAID USB DETACHED FROM AND WITH RESPECT TO TYPE-MICRO SEPARATING THE 2.
4. TYPE-MICRO/USB AS IN claim 3; WHEREIN SAID USB/TYPE-MICRO CONNECT TO CHARGER/SYNC.
5. TYPE-MICRO/USB AS IN claim 3; WHEREIN SAID TYPE-MICRO/USB CONNECT TO FLASH DRIVE
6. TYPE-MICRO/USB AS IN claim 3; WHEREIN SAID TYPE-MICRO/USB CONNECT TO SD READERS
DEPENDENT CLAIM 3
Drawings claims 1
1. TYPE-LIGHTNING/USB AS IN claim 2; WHEREIN SAID TYPE-LIGHTNING/USB BASE IS INTERFACED WITH RESPECT TO LIGHTNING BASE.
2. TYPE C/USB AS IN claim 2; WHEREIN SAID USB IS INTERFACED WITH RESPECT TO TYPE-LIGHTING BASE.
3. TYPE-LIGHTNING/USB AS IN claim 2; 3 WHEREIN SAID USB DETACHED FROM AND WITH RESPECT TO TYPE-LIGHTNING/USB SEPARATING THE 2.
4. TYPE-LIGHTNING/USB AS IN claim 2; WHEREIN SAID TYPE-LIGHTNING/USB CONNECT TO CHARGER/SYNC.
5. TYPE-LIGHTNING/USB AS IN claim 2; WHEREIN SAID TYPE-LIGHTNING/USB CONNECT TO FLASH DRIVE
6. TYPE-LIGHTNING/USB AS IN claim 2; WHEREIN SAID TYPE-LIGHTNING/USB CONNECT TO SD READERS.
